(19) United States
(12) Patent Application Publication
(10) Pub. No.: US 2017/0193406 A1
(43) Pub. Date: Jul. 6, 2017

(54) LOCATION SPECIFIC VISUALIZATION SYSTEMS AND METHODS THAT USE EMBEDDED MEDIA

(71) Applicant: Choros, Inc., New York, NY (US)

(72) Inventor: Gary Berman, Bronxville, NY (US)

(21) Appl. No.: 15/390,314

(22) Filed: Dec. 23, 2016

Related U.S. Application Data
(60) Provisional application No. 62/273,211, filed on Dec. 30, 2015.
(60) Provisional application No. 62/273,213, filed on Dec. 30, 2015.

(51) Int. Cl. G06Q 10/02; G06Q 10/10

(52) U.S. Cl. CPC G06Q 10/02; G06Q 10/1095; G06Q 50/18

(57) ABSTRACT

Location specific visualization systems and methods that use embedded media are provided herein. A method of the present disclosure includes generating an image-based event recommendation based on selections of event parameters and venue suggestions that occur through only provision and selection of images by displaying a plurality of data embedded visual cues, the plurality of data embedded visual cues comprise images of physical venues, the plurality of data embedded visual cues embedding venue attributes, receiving a selection of the plurality of data embedded visual cues, displaying images related to event parameters for an event relative to the physical venue corresponding to the venue suggestion, receiving selections of the event parameters, and generating an event recommendation that includes selected data embedded visual cue of the physical venue in combination with the event parameters.

### CROSS REFERENCE TO RELATED APPLICATIONS

This application claims the benefit and priority of U.S. Provisional Application Ser. No. 62/273,211, filed on Dec. 30, 2015, as well as U.S. Provisional Application Ser. No. 62/273,213, filed on Dec. 30, 2015, all of which are hereby incorporated by reference in their entireties, including all references and appendices cited therein.

### FIELD OF INVENTION

The present disclosure is directed to planning, and more particularly, but not by limitation to project planning that incorporates the use of Smart Photos (‘SP’) or Data Embedded Photo (‘DEP’) photos that are embedded with data related to the venues plus virtualized representations of venues and curated event parameters that are used to generate event recommendations. Venue data and the related curated event parameters can also be virtualized and added to venue floor plans and two or three dimensional models of the venues.

### SUMMARY

According to some embodiments, the present disclosure is directed to a method, comprising: (a) providing a plurality of data embedded visual cues, wherein the plurality of data embedded visual cues comprise staged images of physical venues, each of the plurality of data embedded visual cues embedding venue offers, venue capabilities, and venue market position; (b) receiving selections of the plurality of data embedded visual cues; (c) analyzing the selections to determine one or more venue suggestions that are indicative of venues that correspond to the selections; (d) generating one or more venue suggestions based on the selections; (e) receiving selections of event parameters for an event relative to the venues corresponding to the one or more venue suggestions; and (f) generating an event recommendation based on the selections of event parameters and the selected one or more venue suggestions.

According to some embodiments, the present disclosure is directed to a system, comprising: (a) a processor; and (b) memory for storing executable instructions, the processor executing the instructions stored in memory to: (i) provide a plurality of data embedded visual cues, wherein the plurality of data embedded visual cues comprise staged images of physical venues, each of the plurality of data embedded visual cues embedding venue offers, venue capabilities, and venue market position; (ii) receive selections of the plurality of data embedded visual cues; (iii) analyze the selections to determine one or more venue suggestions that are indicative of venues that correspond to the selections; (iv) generate one or more venue suggestions based on the selections; (v) provide a plurality of event parameters that are curated based on the one or more venue suggestions and a user-profile; (vi) receive selections of the event parameters for an event relative to the venues corresponding to the one or more venue suggestions; and (vii) generating a proposal that comprises the selected data embedded visual cue of the physical venue in combination with the event parameters.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a flowchart of an example method of the present disclosure.

FIG. 2 is a GUI that illustrates visual cues associated with selectable event parameters.

FIG. 3 is a GUI that includes venue attributes and parameters.

FIG. 4 is a GUI that includes potential interactive plan views of a selected venue.

FIG. 5 is a GUI that includes a plurality of visual cues for venues having the same or similar selectable event parameters.

FIG. 6 is a GUI that illustrates selectable event parameters.

FIG. 7 is a GUI that illustrates additional selectable event parameters.

FIG. 8 is a GUI that illustrates an event proposal of event information for a selected venue for a system curated event, the event proposal including the selected data embedded visual cue of the physical venue in combination with the event parameters.

FIG. 9 is a schematic diagram of the system, master venue and party supplier search engines plus the related data bases into which the venue inventory, supplier inventory and their directly related general information, contacts, multimedia, data, product and services information, pricing of products and services, terms and condition and related documents will be inputted, accessed, manipulated and outputted

FIG. 10 is a schematic diagram of a system for creating an inventory of venues and places or spaces for each different type of function, event or party.

FIG. 11 is a schematic diagram of a system for creating a Master Multimedia, Data, Information and Software Interface Portal (‘Venue Choros’) for each venue and place or space based on the each venues SP or DEP, event calendar, room hire, room or venue specifications and staffing, food menus, drinks menus, and additional products and services that the venue offers or the venue can cater for where supplied by the Choros selected party suppliers of additional products and services. (‘Add On’s)

FIG. 12 is a schematic diagram of a system for creating an inventory of selected suppliers of all the additional products and/or services available to the user and venue.

FIG. 13 is a schematic diagram of a system for creating a Master Multimedia, Data, Information and Software Interface Portal (‘Add On Choros’) for each selected party supplier of products or services based on each selected party supplier's SP or DEP, event calendar, hiring costs, pricing, video, logistics, payment terms, contracts. And schematic diagram of a system for populating each Add On CHOROS to facilitate the user interface, review and selection of the additional products and/or services that the venue offers or the venue can cater for where supplied by third party vendors, and the details of the selected suppliers of these products and/or services specific to each selected party supplier of products or services as curated to each Venues abilities and logistical requirements.

FIG. 14.1 is a schematic diagram of a system for populating the Venue Choros to facilitate the user interface, review and selection of the food menus and their details specific to each venue.

FIG. 14.2 is a schematic diagram of a system for populating the Venue Choros to facilitate the user interface, review and selection of the drink menus and their details specific to each venue.

FIG. 14.3 is a schematic diagram of a system for populating the Venue Choros to facilitate the user interface, review and selection of the event calendar details, availability and timing requirements for each venue specific to each venue.

FIG. 15 is a schematic diagram of a system for executing the features of the present technology.

FIG. 16 illustrates an exemplary computing system that may be used to implement embodiments according to the present technology.

### DETAILED DESCRIPTION

The present disclosure is directed to systems and methods for project planning incorporating data embedded photography. In some embodiments, a project is planned through the provision of selections using enhanced multimedia such as encoded and staged images. Users can plan an entire project without being required to answer specific questions in some embodiments, other than selecting multimedia. The selection of multimedia choices informs the systems as to preferences of the user. These preferences are then used to suggest or recommend other enhancements for the project, referred to as event parameters. For example, once a location for the project is selected by the user, the system can intelligently suggest event parameters that match with content embedded or encoded into the location(s) selected by the user.

These processes are generally referred to as visual data provisioning and information collecting. For context, in project and event planning, users are often required to answer a litany of questions that may have little or no relevance to the user's preferences. Some processes request information from the customer prior to providing the customer with information. Some processes require the customer to type in various types of feedback in order for to receive suggestions or recommendations. Users can become disenfranchised with these practices.

In some embodiments, the systems and methods of the present disclosure solve these issues by providing media driven selection processes that engage and inform the user, while simultaneously building a preference profile for the user that can be used to suggest or recommend additional services or products to the user.

These systems and methods immediately provide customers with media, such as images of physical venues that enable the customer to visually determine venue parameters (specific attributes/amenities) of the venue but also to assist the user in determining what is in accordance with their preferences both in terms of the venue and/or associated goods/services that are available at that selected venue.

In some embodiments the present disclosure encodes images of venues with pertinent attributes about the venue. When a user selects an encoded image, no subsequent search of a database is required to obtain relevant information about that venue. Thus provides a technical improvement over systems that require database record lookups to determine attributes of venues.

In some embodiments, each venue is curated and staged such that the images obtained of the venue will visually convey to consumer pertinent information so that they can learn about the venue through viewing of the staged images.

In one or more embodiments, the systems and methods of the present disclosure are configured for organizing, improving, collection, and ultimately curating a venue's food, beverage, room configuration, and other information offer into a database (as well as embedded into images), as well as facilitating selection and booking process through a client-facing application.

By way of non-limiting example, a venue of a private room within a larger facility is curated into the systems of the present disclosure by staging a photo displaying a table within the private room with a maximum number of seats, specific décor, and other visual cues.

In one embodiment the images is encoded with seating data (room seats up to 14); décor data (extremely hip, modern environment; shows appeal suitable for Millennials and early-30s); and venue amenities data (flowers and decorations indicative of mid-range price points).

In some embodiments, the systems and methods use the encoded media, referred to also as a smart photo or data embedded visual cue, where the system allocate key venue offers, venue capabilities, and venue market positioning. Venue offers can include, for example, discounts, available food and drink information, and so forth. The venue capabilities refer to the physical attributes of the venue such as size, capacity, and layout—just to name a few. Venue market positioning refers to the aesthetic or cultural demographics of the venue such as rustic, chic, elegant, formal, casual, 21 and over, child friendly, Millennials, gen-x, and so forth.

In some embodiments, the present disclosure obtains information by presenting these data embedded visual cues (e.g., enhanced or encoded images) to a customer. When a customer selects or passes over a particular image, the systems interpret these actions as being indicative of suitability/unsuitability of one or more venues relative to their preferences.

When a customer indicates that the like or prefer an image of a venue the systems have directly and indirectly obtained an enormous amount of information about their preferences and therefore a type of event they are likely to host at the venue. Once a user clicks on as few as two of these enhanced photos the systems of the present technology can build robust offers for the user.

For example, by liking an image for Charlie Bird's private room, the system immediately determines that the user is interested in venues for a dinner party up to 10 people, moderately priced, with a very neutral décor. The system can use this single clicked image to imply that the user is someone over 40 and someone conservative.

If in addition to selecting Charlie Bird's private room, if the user clicked on the a la Carte menu or a fixed price or platters menu, the second click informs the system of the user's food preferences and food budget spend. The system can execute a predictive spending algorithm that accounts for venue specific and industry averages to determine additional pricing information. For example, a user who intends to spend $70/head on food would spend anywhere from $40-55 on alcohol. From these two clicks on the room and type of food the system can intelligently and inferentially match beverage spend and beverage selection. The predictive spending algorithms utilized herein will involve use of historical spending metrics from the venue or similar venues. These spending metrics can be utilized alone or in conjunction with user spending metrics for user that are similar to the user who is interested in securing the venue for an event. These

All of this information can be used by the system to generate a quote and even provide suggestions/recommendations of add-on suppliers/vendors that have been curated and that are suited to the tastes of someone who would select a room like Charlie Bird. That is, the system can select one or more vendors that provide ancillary products/services and these vendors are curated to ensure that they are appropriate for the venue and tailored to preferences of the user (as determined through their interactions with the images and options provided).

In sum, the present disclosure provides technical advantages by way of photos (e.g., media) embedded data and related algorithms that provide clear visual clues to a user that are in accordance with their preferences. Systems provide the user with instant communication as to whether a selected location will accord with their preferences using quick visual references.

A further benefit to the user is that add-on suppliers are not just a list of qualified service or product providers but rather these suppliers are curated; their products and services specifically suit the profile of the user who will choose a certain venue based on their preferences. User receive this information through system generated visual clues based selections of curated photos of their products and services that suit the selected venue.

The venues promoted on by the systems will benefit based on gathering and analysis for data related to user selections.

The systems of the present disclosure implement heuristics from user selections to learning about preferences of a particular user, particular venues selected by these users, as well as from negative inferences related to what these users did not select. The systems of the present disclosure use these heuristics and continually update and improve their suggestions based on spending habits and other relevant collected information.

Again, some advantages of the present disclosure involve careful automated curation and visual setup of a venue to convey as much information as possible to users without them having to read copious amounts of text or enter textual responses, and for the systems to gather information about event being planned without the user having to enter textual information.

By conveying information using encoded photographs, information is digestible not just because it's visual, but the information conveyed is conveyed in incremental stages. A single encoded photograph provides an enormous amount of information to users. This encoded photo can convey the same amount of information available in a page of narrative that that a user is less likely to read. This same information is used not only to carefully curate the experience users have, to ultimately match users with a preferred venue and offer, but also provide invaluable information to venues that enable them to maximize their offer and therefore maximize revenue.

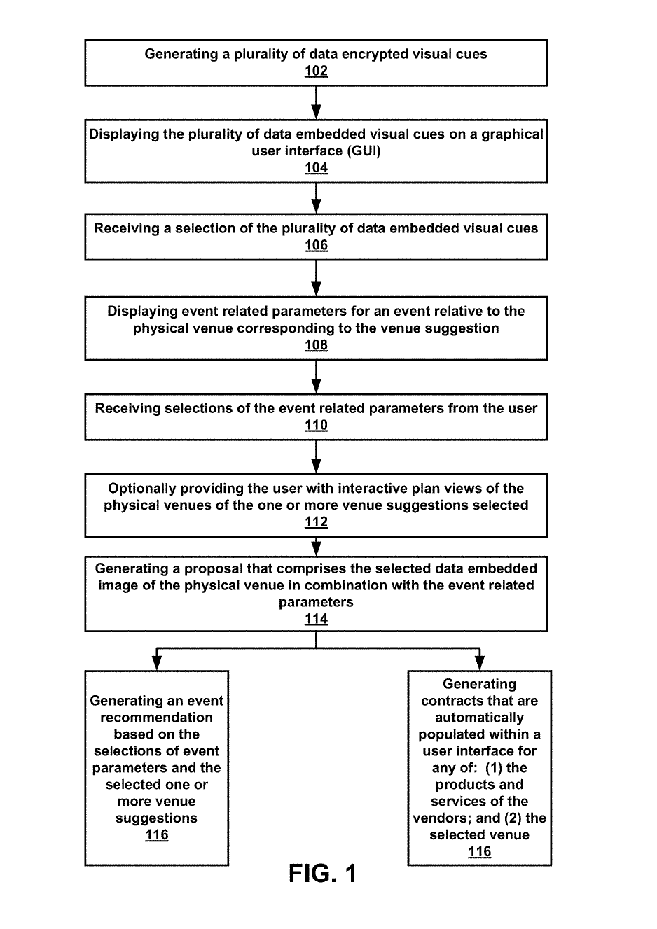

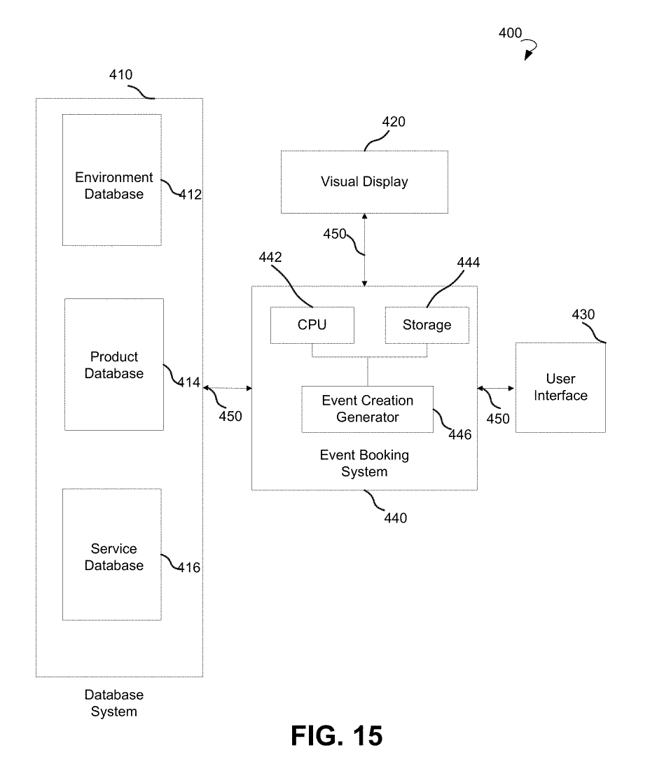

Referring now to FIG. 1, a flowchart of an example method of the present disclosure is illustrated. The method involves the generating of an image-based event recommendation based on selections of event parameters and venue suggestions that occur through only provision and selection of images. This method can be implemented using the system described and illustrated with respect to FIG. 15.

In some embodiments, prior to the provision of images to the user, the method includes a step 102 of generating a plurality of data embedded visual cues. In some embodiments, these data embedded visual cues comprise images of physical venues. According to some embodiments, these images comprise staged images of venues.

In one embodiment, the step of generating the plurality of data embedded visual cues comprises embedding venue attributes into the images. For example, venue attributes such as size, cost, calendaring, appearance, capacity, location, and so forth are encoded into the image using, for example, metadata tags or other encoding technology.

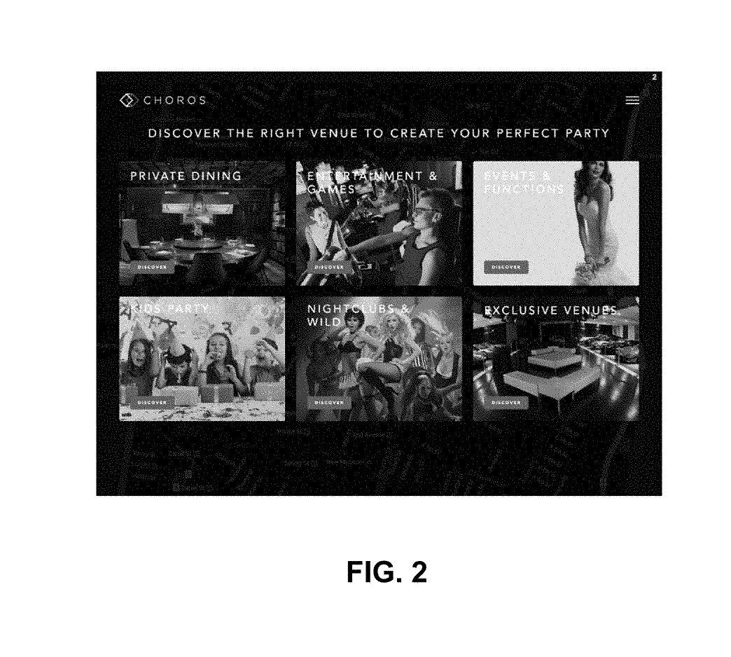

The method includes a step 104 of displaying the plurality of data embedded visual cues on a graphical user interface (GUI). An example of curated venue images (e.g., data embedded visual cues) incorporated into a GUI is illustrated in FIG. 2, which is described in greater detail below. In one embodiment, each of the visual cues is associated with a selectable event type. For example, one visual cue could include selectable event type of private dining, another visual cue could include a selectable event type of birthday party, and so forth. When one of these visual cues with a selectable event type is chosen, the GUI can be repopulated with additional options such as other visual cues of venues having the same or similar selectable event type.

In some embodiments, the method comprises a step 106 of receiving a selection of the plurality of data embedded visual cues. For example, the user clicks on one or more of the data embedded visual cues through the GUI.

Once selected, the system can obtain curated options for the venue and then execute a step 108 of displaying event parameters for an event relative to the physical venue corresponding to the venue suggestion. For example, the system can display food, beverage, floral, musician, or other event parameters to the user for selection. Again, the system specifically and heuristically selects these event parameters based on the user's selection of a venue. This ensures that the event parameters suggested by the system are relevant based on the venue. By way of example, the system would not suggest low priced food and beverage options if the user selected a very exclusive and private venue.

In one embodiment, the method includes a step of 110 receiving selections of the event parameters from the user. For example, the user may select a menu of a caterer that was provided as an event related parameter based on the selection of a specific venue.

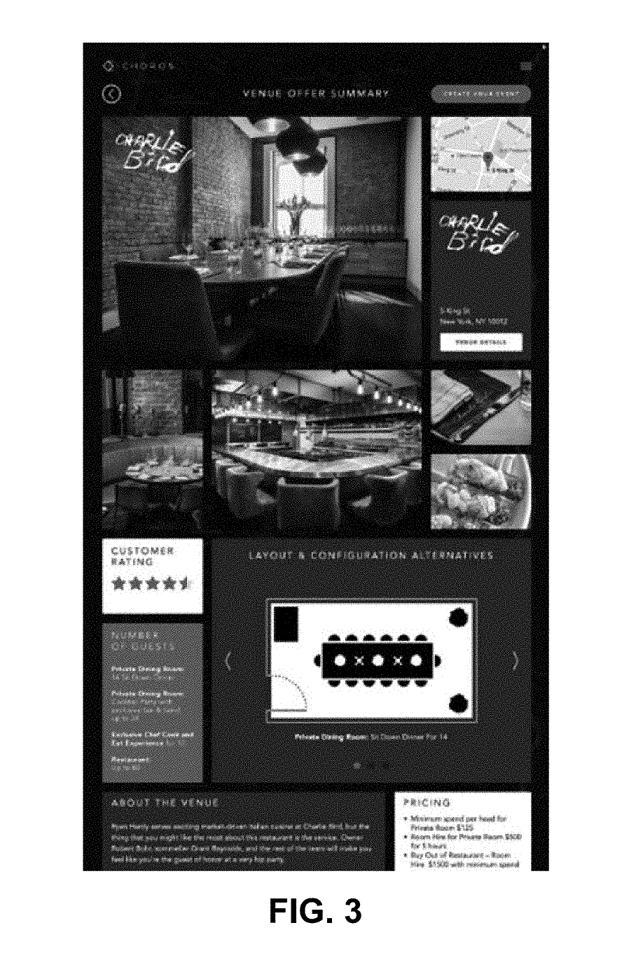

In accordance with the present disclosure, the method includes a step 112 of optionally providing the user with interactive plan views of the physical venues of the one or more venue suggestions selected. In some embodiments, the interactive plan views comprising venue objects that are movable within the interactive plan views. For example, a venue object could include a table with chairs, room dividers, and so forth. An example GUI comprising event related parameter and interactive plan views is illustrated and described with respect to FIG. 3.

In some embodiments, the event parameters are populated as objects within SP or DEP's. For example, if the user selects a floral arrangement for tables in the venue, the SP or DEP of the venue will update to include the floral arrangement on one or more of the tables to provide a real representation of the venue with the selections made by the user.

Once the user has made all desired selections, the method includes a step 114 of generating a proposal that includes a SP or DEP and or (selected data embedded visual cue) other similar representation of the physical venue in combination with the event parameters. For example, a two dimensional representation can be generated that is embedded/encoded with the selected information for the venue (e.g., service and product options). The two dimensional embedded images can be combined with the two dimensional plan views and/or textual information about the venue or services/goods selected by/for the user.

It will be understood that the selected data embedded visual cue can comprise an augmented two dimensional rendering or plan model of the venue that has been arranged based on user selections and interactions with interactive plan views of the venue.

Optionally, the method includes a step 116 of generating an event recommendation based on the selections of event parameters and the selected one or more venue suggestions. The event recommendations can comprise any additional or Add One goods or services that the system determines would be appropriate for the venue, the user, and/or the event.

Alternatively a step 118 of generating contracts that are automatically populated within a user interface for any of: (1) the products and services of the vendors; and (2) the selected venue. Thus, if the user selects specific food, beverages, floral arrangements, entertainment, and so forth, the system can generate pre-negotiated contracts for each of these vendors.

As mentioned above, the event parameters are curated from supplier goods and services such that they correspond to the embedded venue offers, venue capabilities, and venue market position of the selected venues. In sum, the supplier goods and services are curated and selected based on the user's selection of a venue.

In some embodiments, the step of providing a plurality of data embedded visual cues comprises generating SP or DEP's of the physical venues that are staged in accordance with the embedded venue offers, venue capabilities, and venue market position. In other embodiments, the data embedded visual cues are staged images created by photographers. These SP or DEPs can be generated for each unique vendor in order to showcase their goods.

As mentioned above, venue offers can include, for example, discounts, available food and drink information, and so forth. The venue capabilities refer to the physical attributes of the venue such as size, capacity, and layout—just to name a few. Venue market positioning refers to the aesthetic or cultural demographics of the venue such as rustic, chic, elegant, formal, casual, 21 and over, child friendly, millennial, gen-x, and so forth. Again, these are all merely example representations of these attributes.

The following paragraphs are descriptive of example graphical user interfaces (GUIs) that are implemented to provide the plurality of data embedded visual cues, associated vendor information (event parameters), interactive plan views, augmented two dimensional models, and so forth.

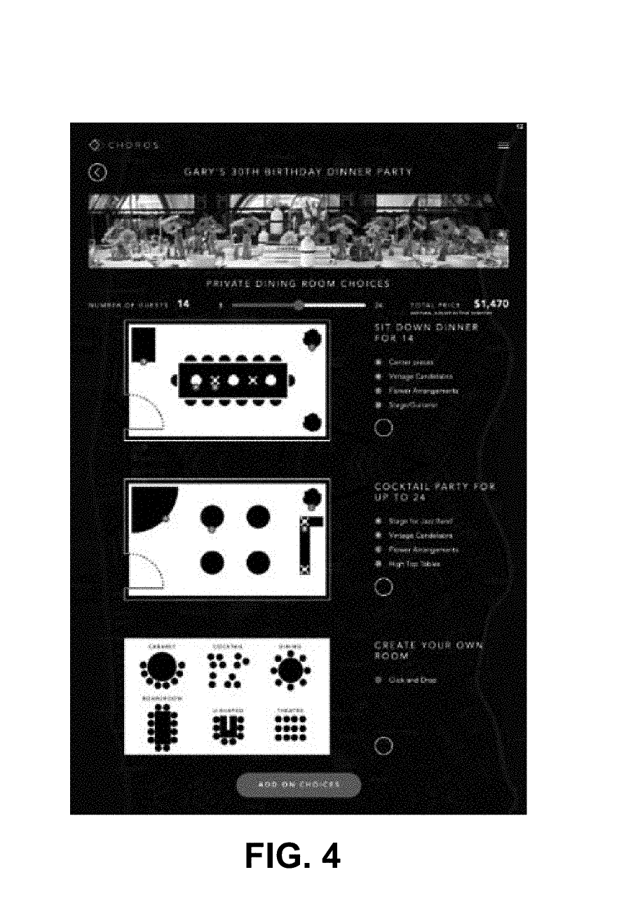

FIG. 2 is a screenshot of a GUI that comprises visual cues for each of private dining, entertainment and games, and so forth. These visual cues are associated with selectable event types. Selection of private dining will cause the display of a GUI illustrated in FIG. 3. The GUI of FIG. 3 illustrates additional aspects or attributes of the venue such as venue offers, venue capabilities, and venue market position. Selection of the layout and configuration details results in the display of the GUI of FIG. 4. The GUI of FIG. 4 provides interactive plan views of a venue selected by the user. The user can manipulate the objects in the 2D interactive plan view such as tables and chairs.

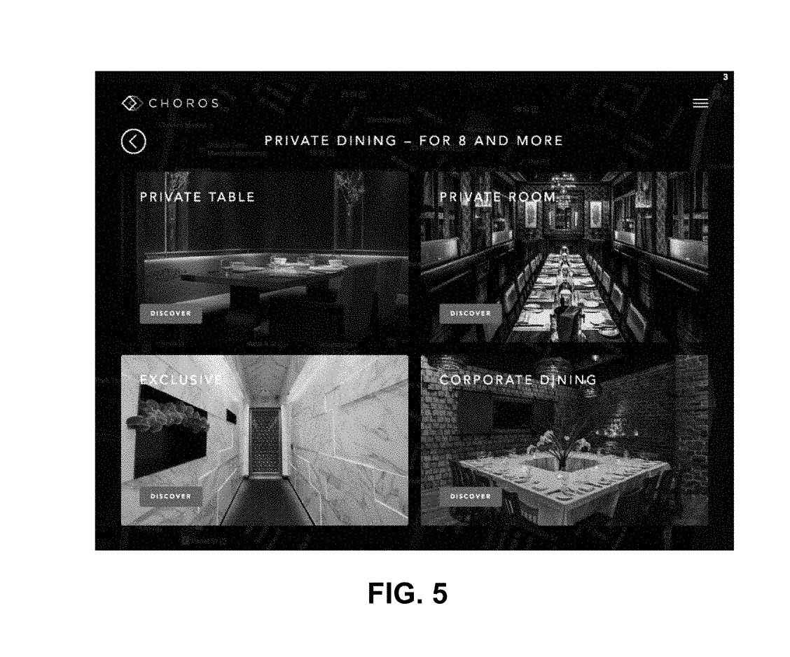

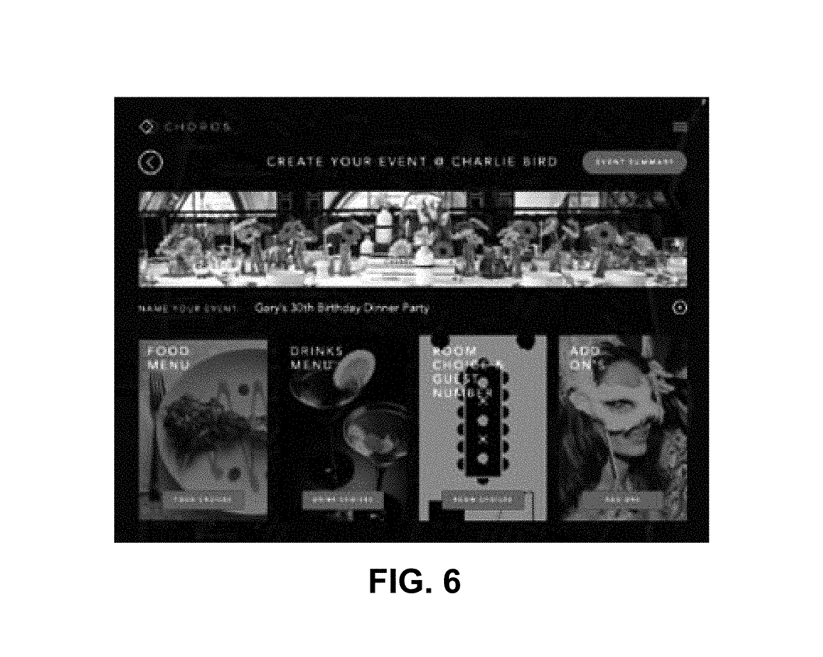

FIG. 5 illustrates a GUI that has additional visual cues that correspond to the selectable event type of private dining. These selections allow the user to further refine their request. FIG. 6 illustrates a GUI that includes event parameters for a selected venue. As mentioned above, the event parameters include services and products that are curated specifically for the venue and the user.

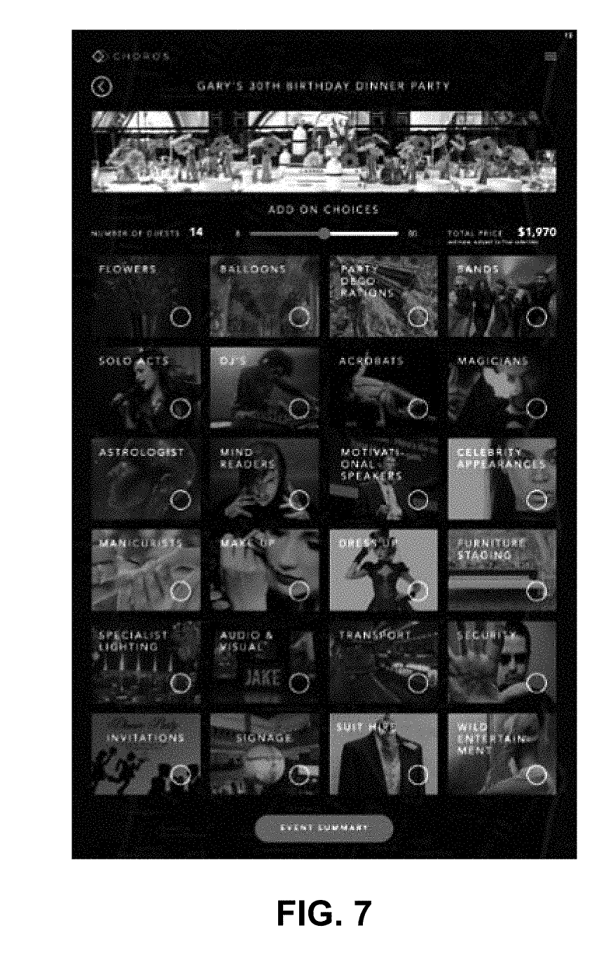

FIG. 7 illustrates another GUI that includes extensive selectable event parameters for creating an event.

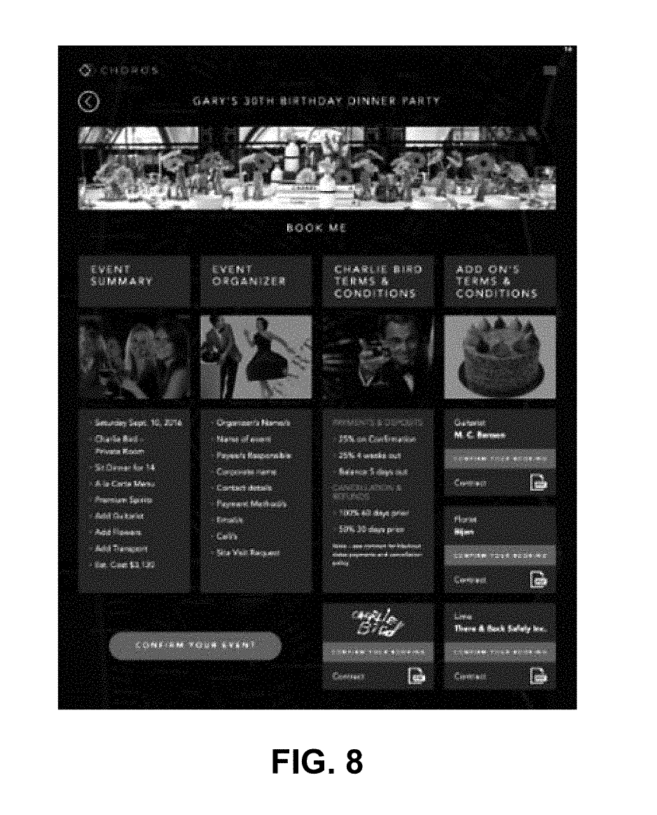

FIG. 8 is a summary or recommendation of all selected event parameters for a selected venue. The user can confirm their event, which results in the generation of contracts and the ordering of services and products, as well as the reservation of the venue.

The following paragraphs provide additional example embodiments and implementations of the present disclosure related to specific database structures and implementations.

The present disclosure is directed to the field of locating event, party and function places and spaces, the event planning itself, and more specifically, but not by limitation, to systems and methods that provide users with a user interface through which a user may create and book a customized event, function or party by drawing upon mixed media, data, information and software relating to a specific venue and related third party vendors (and the products and services they provide) that are stored in different formats in a central database. A “Choros” is defined as the creation of a Multimedia, Data, Information and Software Interface Portal. It should be understood that the above definition is illustrative and is intended to cover alternatives, modifications, and equivalents. The Choros technology enables the creation and use of, but not by limitation, the Venue Choros, Supplier Choros, Event Choros, Event Organizers Choros and Event Management Choros. Multiple groups and/or types of users can interface with each or a single Choros simultaneously creating a systemized process of locating, creating, booking and managing an event, function or party.

The present technology is directed to the creation and booking of a customized event, function or party, through various user interfaces that draw upon mixed media, data, information and software relating to event venues and third party vendors and the products and services they provide, which are stored in different formats in a central database. The system includes a database of venues and their services and products, including, but not limited to, food menus, beverage menus, rooms, places, and spaces, configurations of rooms, places, and spaces, and other unique information relating to the venue. The system further includes a user interface allowing the user to select from a vast array of venues, select products and/or services to be utilized within the venue, configure the selected room, place, or space using “drag and drop” functionality, view the venue calendar of availability, automatically populate the necessary contracts for the selected venue and third party vendor products and services, execute the contracts through “one click” agreements, coordinate and collect deposits for the venue and third parties providing products and/or services. The technology creates the use of Choros's. A Choros contains a collection of data and multimedia related to a specific venue. The data and multimedia includes, but is not limited by, food and drink menus, photographs, video, documents, text information, as well as, descriptions of products and services and links to other Choros's or related websites. The Choros allows users that are unrelated, such as, the customer or party organizer, venue and venue suppliers and guests to upload multimedia files, documents, plan, configurations and input data, view data, share data, manipulate data and update the data all held in the Choros.

In addition, the present technology is directed to the creation of enhanced virtual and visual experiences on computing devices, more specifically, but not limited by, systems and methods that provide users with a virtual room user interface. The system includes a venue database, a product and services database, a virtual room database comprising a virtual representation of actual venues, and an environmental database having a collection of data points defining the actual venue, services and products. The system further includes a user interface allowing the user to select from a vast array of venues, view a virtual representation of the selected venue, select products and/or services to be utilized within the venue, arrange the virtual products and/or services within the virtual space, view the venue calendar of availability, book the selected venue configuration based on the user's preferred virtual venue creation, and provide feedback to the vendor regarding the user's overall experience.

The creation and booking of events can be executed on computing devices, which include but are not limited to: phones, tablets, watches, glasses, and other forms of wearable computing.

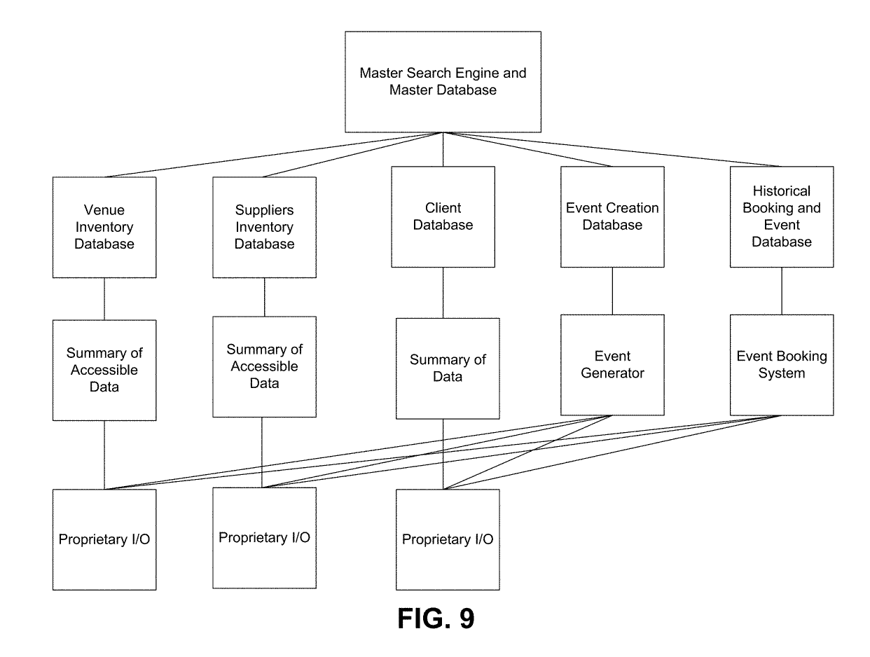

FIG. 9 is a schematic diagram of the system and the related data bases into which the venue inventory, supplier inventory and their directly related general information, contacts, multimedia, data, product and services information, pricing of products and services, terms and condition and related documents will be inputted. There after the data may be accessed and manipulated by the various groups of users. FIG. 9 is also a schematic diagram of the system and the related data bases into which the client information, creation of the event, booking of the event and the directly related information for the events, clients, venues and suppliers including, but not limited by, contacts, multimedia, data, selected product and services information, terms and condition of trade, contracts, payments and related documents will be inputted and accessed by the various groups of users.

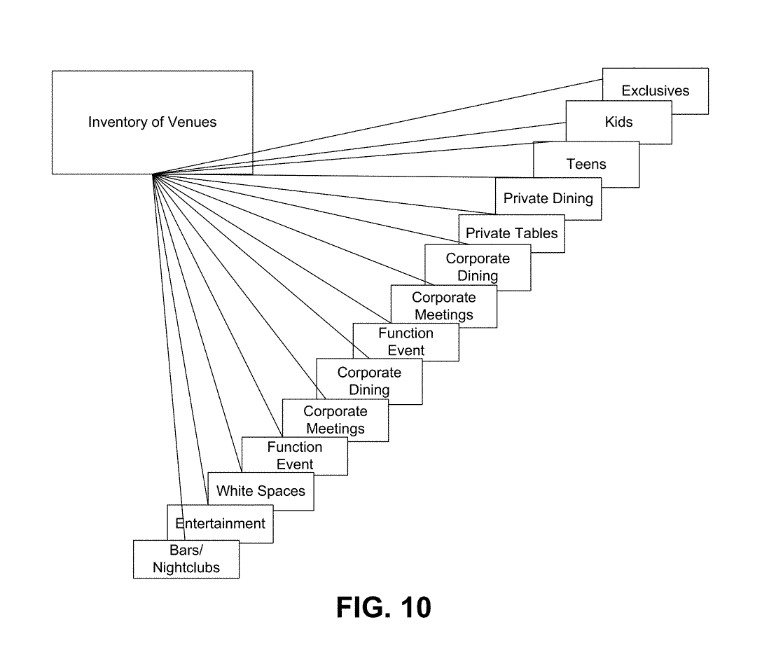

FIG. 10 is a schematic diagram of a system for creating an inventory of venues and places or spaces for each different type of function, event or party.

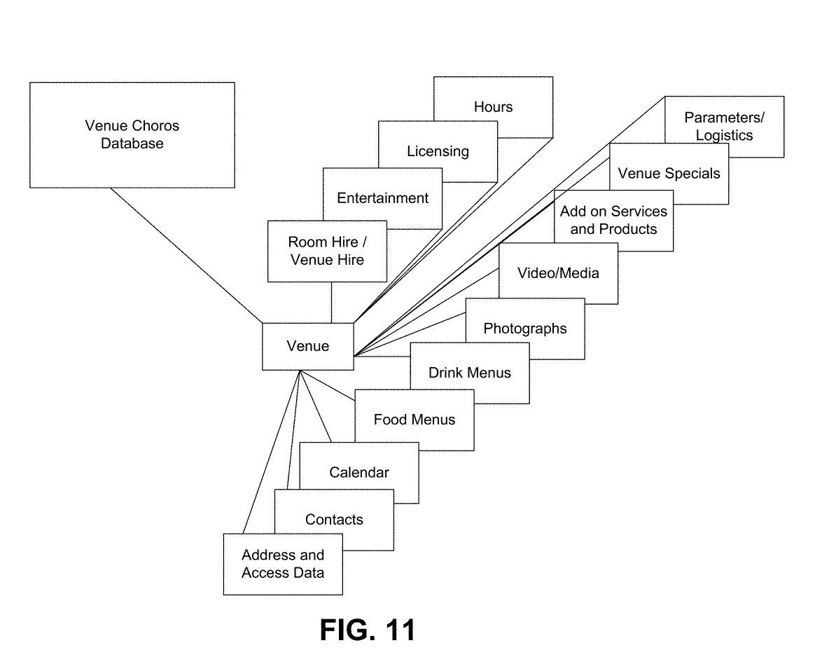

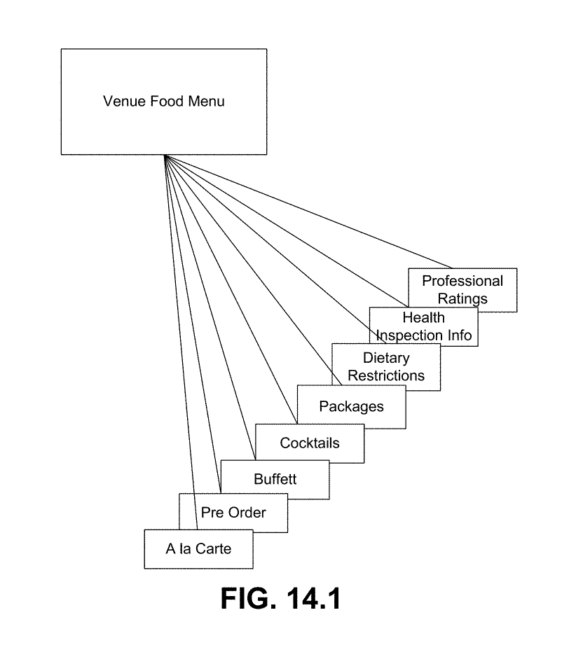

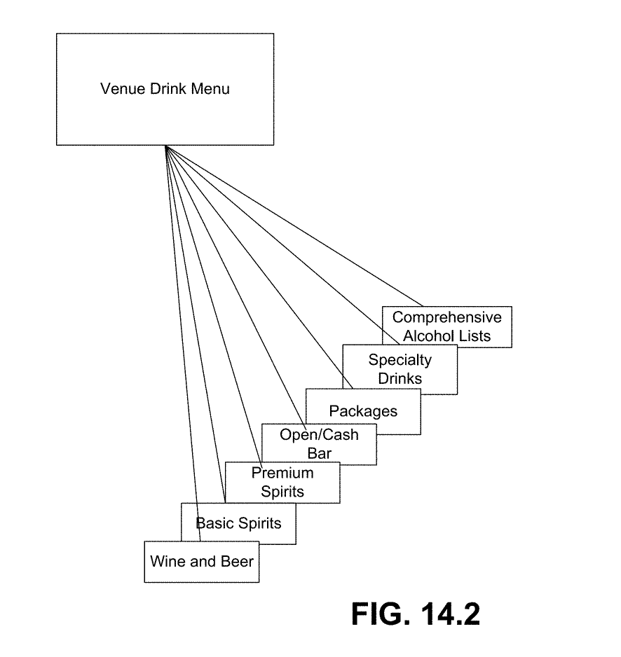

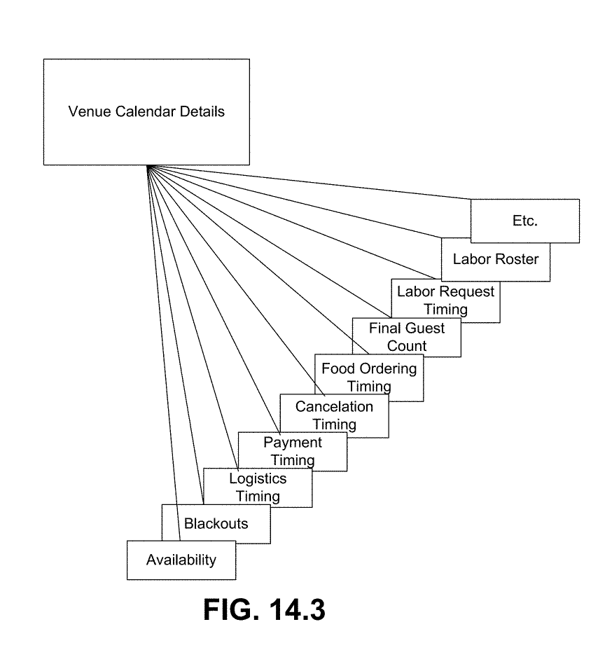

FIG. 11 is a schematic diagram of a system for creating a Master Multimedia, Data, Information and Software Interface Portal (‘Venue Choros’) for each venue and place or space based on each venue's event calendar, room hire, room or venue specifications and staffing, food menus, drinks menus and additional products and services that the venue offers or the venue can cater for where supplied by third party vendors. In addition, FIG. 11 is a schematic diagram of a system for populating the Venue Choros to facilitate the user interface, review and selection of the specifications and details specific to each venue. FIG. 14.2 is a schematic diagram of a system for populating the specifications and details of each venue.

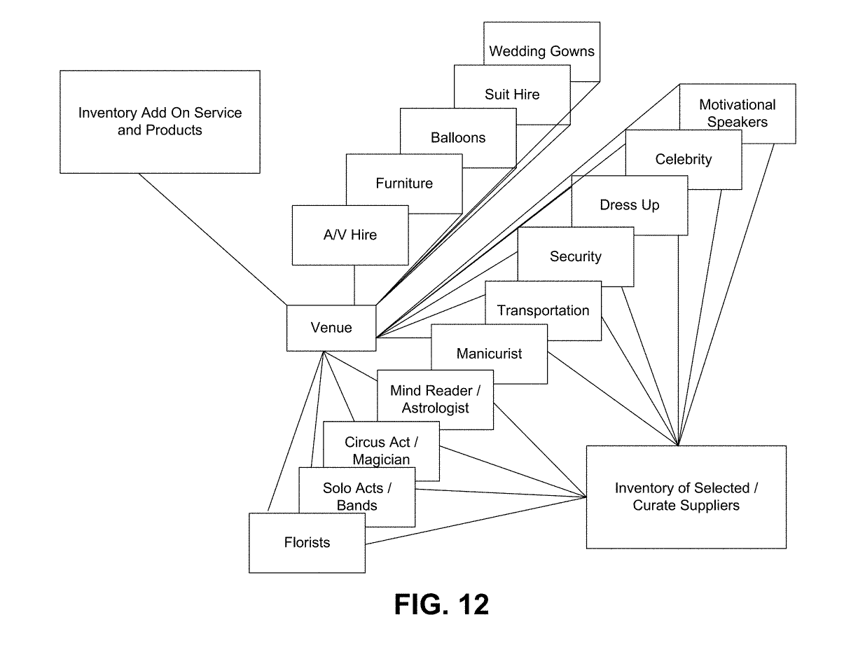

FIG. 12 is a schematic diagram of a system for creating an inventory of selected suppliers of all the additional products and/or services available to the user and venue. In addition, FIG. 12 is a schematic creation of the Supplier Multimedia, Data, Information and Software Interface Portal (‘Supplier Choros’).

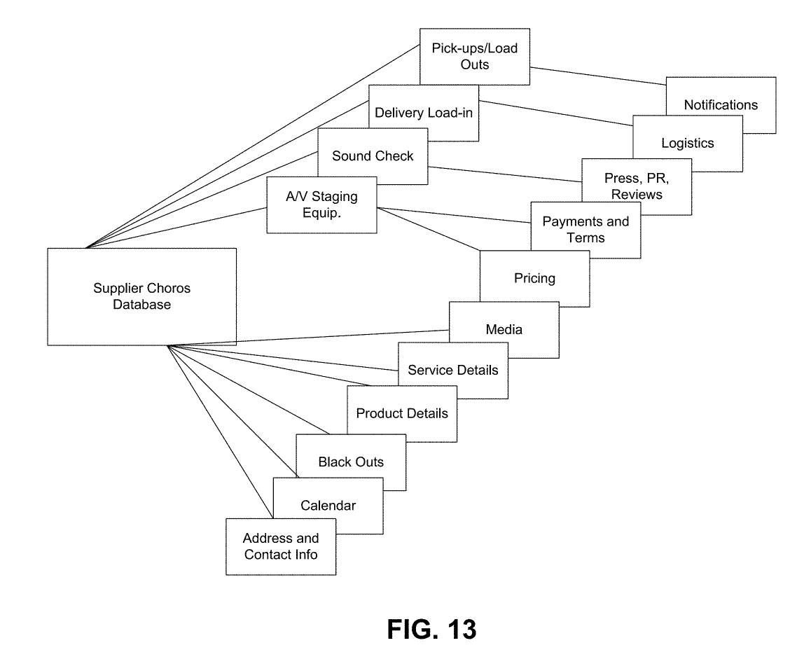

FIG. 13 is a schematic diagram of a system for populating each Supplier Choros to facilitate the user interface, review and selection of the additional products and/or services that the venue offers or the venue can cater for where supplied by third party vendors, and the details of the selected suppliers of these products and/or services specific to each venue.

FIG. 14.1 is a schematic diagram of a system for populating the Venue Choros to facilitate the user interface, review and selection of the food menus and their details specific to each venue.

FIG. 14.2 is a schematic diagram of a system for populating the Venue Choros to facilitate the user interface, review and selection of the drink menus and their details specific to each venue.

FIG. 14.3 is a schematic diagram of a system for populating the Venue Choros to facilitate the user interface, review and selection of the event calendar details, availability and timing requirements for each venue specific to each venue.

FIG. 10 represents a schematic illustration of a venue inventory organized into event specific subcategories, with FIG. 11 and FIG. 12 breaking this down into inventories of products and/or services available for each venue. In some embodiments, the system would provide an inventory of venues that are organized into a variety of categories, including but not limited by private dining, entertainment events, private functions, kids parties, adult parties, corporate meetings, and exclusive events. The user would then be presented with a database containing photographs of each venue, allowing the user to compare and contrast each option and select multiple venues that appear to meet their specific event requirements. The user's venue selections would be collected and populated in a personalized venue database specific to the user. Each of the user's venue selection may contain a database of available products and/or services, a calendar of availability, venue specifications, and planning requirements specific to each venue and/or vendor.

In some embodiments, the user would be given the option to select their preferred geographical location, however, the system would not require the user to specify their location at the outset of this user experience. As such, the user is given the opportunity to view various venues without the system limiting available venue options based on geographical restrictions.

The user would then select one of the options in their personalized database to begin creating their event. Once this selection is made, the user interface provides a virtual representation of the actual venue, created from an environmental database comprising a collection of data that defines the actual venue space. For example, the virtual representation can be generated from images, video, audio, and combinations thereof. A panoramic view of a space can be obtained using methods known to one of ordinary skill in the art.

The user then enters the Venue Choros and is provided with a summary of the key information particular to their selected venue. As shown in FIG. 13, FIG. 14.1, FIG. 14.2, and FIG. 14.3 the venue information summary or inventory of venue details includes, but is not limited to, photos, layout and configuration alternatives, guest capacity limitations, the venue address, a street map of the venue location, venue pricing options, beverage summaries, food summaries, list of commercial licenses the venue possess, various reviews of the venue, entertainment options, available additional products and/or services, and any possible dress code requirements. The user interface then allows the user to begin creating their event with the available products and/or services available with their selected venue by creating a new virtual room. Therefore, the user can create a virtual representation of an event they desire to host at the specified venue. The user can, for example, arrange furniture, place decorations, food, and/or other event details in the room to create a virtual model of the venue, arranged as the user prefers.

The system, in addition to the environmental database, may include a products database comprising a collection of products specific to the user's chosen venue, and a services database comprising a collection of services specific to the user's chosen venue. The user interface allows the user to select from various categories within the products and/or services databases, including but not limited by, food menu, drinks menu, room configuration options, furniture options, staffing and additional extras that are specifically provided by the user's selected venue. Once the user has made their venue specific selections, the user is able to select, confirm or reselect the chosen products and/or services within the venue to meet their desired configuration or layout of the room and or venue and number of guests and budget.

FIG. 12 represents a schematic illustration of an inventory of additional products and/or services offered by third party vendors. In some embodiments, the user interface allows the user to select additional products and/or services offered by selected third party vendors specific to each venue. The additional extras inventory will provide the user with products and/or services that the user's venue offers exclusively, such as, but not limited by, flowers, balloons, decorations, staged décor, transportation options, security options, circus acts, mind readers, astrologers, magicians, singers, bands, disk jockeys, key note speakers, and celebrity appearances. For example, if the user is planning a child's birthday party, the user may select various third party vendors that provide products and/or services including, balloons, birthday decorations, clown acts, and/or magicians. Once the user has made these selections, they are able to view the totality of the event in the Event Chorus including the selected products and/or services from the Venue Chorus and to select, confirm or reselect the chosen venue products and/or services and additional products and/or services offered by selected third party vendors to meet their desired configuration or layout of the room and or venue and number of guests and budget.

FIG. 12 represents a schematic illustration of the inventory of products and/or services that are available and exclusively offered by the venue. In some embodiments, the venue specific inventories are organized into subcategories such FIG. 13, FIG. 14.1, FIG. 14.2 and FIG. 14.3 For example, in FIG. 14.1 if the user selects the food inventory, the user interface would present the user with options, such as, but not limited by dietary restrictions, buffet options, platters, pre-ordered meals, a la carte service, and exclusive catering options. In another instance, in FIG. 14.2 the user may select the drink inventory, which would present the user with options such as, but not limited by wine, beer, spirits, premium sprits, open bar service, all you can drink options, beverage packages, and exclusive packages that include bar staff and cocktail selections. For instance, the user may desire a sit-down catered event, and select the pre-ordered meal option, which would require catering staff. Given that the user has opted for a more formal dining arrangement, the user may then elect to have beer, wine, and premium spirits served tableside, which would require bar staff. Once the user has made these selections, they will be able to arrange virtual representations of these products and/or services within the virtual venue in a configuration that allows the guests optimal room to sit and move about from table to table, while providing the catering and bar staff with the necessary room to efficiently perform their tasks.

In some embodiments, once the user has made their desired selections from the various categories, the system may include a user interface for selecting these products and/or services and arranging the products within the room or venue. Once the user is satisfied with their selections and venue configuration, the user can view a summary of the event they have created. The user may access the event summary interface at any point during the user experience to view the event they are creating. The event summary interface includes, but is not limited to, a summary of the user's selections, pricing of all the user's selected menus, the option for the user to change the number of guests or the menu selections, the option to enter the user's preferred event date, and the option for the user to book the event that they have created. Unlike prior art, the user interface may not allow the user to enter their preferred date until they have created their event within the Event Choros, so as not to restrict the user's options unnecessarily.

FIG. 14.3 represents a schematic illustration of the calendaring system allowing the user to schedule their created event. In some embodiments, once the user has entered their preferred date, the user is directed to the main virtual venue and is presented with the venues calendar of availability. If the user's preferred date is not available, the user interface presents the user with alternative dates or with dates that are available at other venues originally selected by the user at the beginning of the user experience. The user can choose to book the event they have created or can choose to select another venue and repeat the process of event creation. As such, the user would be presented with an interactive visual representation of the venue's calendar of availability. The calendar may be presented in a 12 month calendar format, a date and time specific format, or the like. If the user's preferred date is not available, the user may view alternative dates and times and select and book the event based on their preferred alternative booking option presented within the calendar.

In some embodiments, the user interface allows the user to privatize their information with a personalized password. The user interface includes a summary of user's created event, allows the user to enter their personal information, such as, but not limited by name and contact information, allows the user to enter credit card and/or debit card information for either single or multiple payers, provides the venue's deposit requirements, the venue's cancellation policy, the venue's contract for the user to sign and send back to the venue, a summary of planning requirements from the user and the venue, price quotes from any additional extras that will be provided by third party vendors, point of contact information for the venue, guest names and/or contact information, and payment and/or deposit options.

In various embodiments, once the user has booked their event, a calendaring system accesses information collected from the venue, the third party vendors, and the user pertaining to, but not limited by timing requirements, set up requirements, billing requirements, scheduling requirements, and equipment requirements. The venue and the third party vendors are able to communicate directly by sending and receiving notifications based on this information, thus eliminating post-booking user involvement and streamlining the entire event planning process.

According to some embodiments, the system can be configured to receive or collect input from the user regarding the user's overall experience and satisfaction. The user interface allows the user to review the venue, including but not limited by a review of the products and/or services provided by the venue and the various stages of event execution. Reviews may be collected from a variety of users including, but not limited by the venue, the users, third party vendors, and guests. Further, the interface allows third party vendors and the venue to exchange reviews and feedback regarding their respective experiences and possible improvements for future events and interactions. The system also provides a final bill of the user's event, which may include venue fees, third party vendor fees, and amounts paid by each party.

In some embodiments, the system can aggregate and store the users' feedback, the guests' feedback, the venues' feedback, third party vendors' feedback, and any other individuals eligible to provide feedback. The system then uses the feedback to create a representation of the overall satisfaction of the user experience. These representations can be utilized to identify relevant patterns that are linked to positive experiences and outcomes, as well as, negative experiences and outcomes. The system can then use the analyzed user experience feedback to deduce areas of improvement or determine what aspects of the process are generating positive feedback. For example, the system may create a graphical representation of the overall sentiment of the users' experience, which is presented to in a visual display that can be utilized and analyzed to create improvement goals for future user experiences.

In some embodiments, the system provides a way for the user to enter a “Bird's Eye view” mode in which the user can view the virtual room from an elevated view or from any other position or angle the user desires. In “Bird's Eye View” mode, the user's view starts from the initial position of looking down upon the virtual room, allowing the user to view the entire integrated virtual world from above. The user can then change their view angle, affording them different visual perspectives of the virtual space. This view can be accomplished by using an input device such as a joystick, keyboard, mouse, and the like. In addition, this view can be adjusted on various touchscreen and mobile devices in the following ways: (1) tilt up/down by dragging a finger up/down onscreen; (2) spin the world clockwise/counter clock-wise about a central axis perpendicular to the floor of the world by dragging a finger left/right onscreen; (3) zoom in/out of the world using standard pinch gesture; and (4) shift the world left/right by dragging two fingers onscreen.

One of the functions of some embodiments of the virtual room interface is to offer the user a tailored and interactive process that allows the user to utilize a virtual empty space by organizing, placing, and visualizing virtual representations of products and/or services within the virtual space. In addition, the user is able to select and book an event based on personalized preference to include, the venue and associated products and/or services. Thus allowing the user to streamline the room planning process for various events with little to no inconvenience to the user.

Another main function of some embodiments is to provide the user an event planning process that requires little post-booking user involvement. Once the user has created and booked their event, the majority of the actual event execution is performed by the venue and the third party vendors, with little or no involvement or inconvenience to the user.

Additionally, in some embodiments, the main purpose of the system and interface is that through a selected Choros, users that are unrelated such as the customer or party organizer of the event, the selected venue for the event, the event additional service suppliers and the guests of the event can download or upload multimedia files, documents, plans and configurations of the venue. Thereafter the users can either download data, input data, view data, share data, manipulate data and/or update the data all held in the Choros with the purpose of selecting a venue for an event, choosing products and services for the event, booking and paying for the event and additional products or services and managing the coordination process through until completion of the event.

Referring now to FIG. 15, a schematic diagram of one embodiment of the event creation and booking user interface. FIG. 15 can be modified to suit individual circumstances. The event creation and booking user interface system or system 400 generally includes a database system 410, visual display 420, user interface 430, and event booking system 440. The individual components of the system 400 are operatively connected by communications medium 450. The various components of the system 400 may be representative of various system components, such as, but not limited by desktop computers, server computers, laptop computers, tablet computers, and the like. Embodiments of the present disclosure are not limited to any particular computing system, application, device, or network architecture, and may be adapted to integrate new computing systems and platforms as they become available.

Communication medium 450 is intended to be representative of any medium for transferring data between the various components of the system 400. Communication medium 450 may take any form and may include or interface with any one or more of, for instance, a local intranet, a PAN (personal Area Network), a LAN (Local Area Network, a WAN (Wide Area Network), a MAN (Metropolitan Area Network), a virtual private network (VPN), a storage area network (SAN), a frame relay connection, an Advanced Intelligent Network (AIN) connection, a Synchronous Optical Network (SONET) connection, a digital T1, T2, T3, E1, or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access), or TDMA (Time Division Multiple Access), cellular phone networks, GPS (Global Positioning System), CDPD (Cellular Digital Packet Data), RIM (Research in Motion, Limited) duplex paging network, Bluetooth radio, or an IEEE 802.11-based radio frequency network.

Event booking user interface system 440 includes CPUs 442, storage 444, and event creation generator 446. CPU 442 is a programmable logic device that executes instructions, logic and mathematical processing performed in executing user applications, such as the event creation generator 446. Storage 444 stores application programs and data for use by the event booking system 440. Common storage devised includes hard-disk drives, flash memory devices, optical media and the like.

System 440 is configured to generate a booking for a user created event and to display the entire contents of the booked event to the users of the event creation and booking user interface system 400 through visual display 420. Visual display 420 can be any device adapted to display the content of the booked event, such as a monitor or screen connected to the event creation and booking user interface system 400. Alternatively, the visual display 420 may be incorporated to display multimedia content. For example, a user may access the created or booked event user interface system 400 remotely via an internet web-browser on a public or private network. The user may interact with the created or booked event user interface system 400 and view the details of event and there changes through visual display 420 incorporated into the web-browser.

Individuals may interact with the system 400 using a variety of interfaces 430. For instance, user interface 430 can include desktop computers, server computers, laptop computers, tablet computers, cell phones, and the like.

Database system 410 is used to store a collection of environment data 412, product data 414, and service data 416. The environment data, the product data, and the service data are used by the event booking system 440 to generate a simulated view of the user's event creation. The database system 410 may be located remotely from the event creation and booking user interface system 400 and operatively connected to the event booking system 440 through communication medium 450. In an alternative embodiment, the database system 410 may be arranged as part of or integral with the event creation and booking user interface system 400.

Environment data 412 is used by the event generator to generate a virtual representation of an actual event. The environment data 412 may define various attributes of the venue and may include, but not limited by measurements of the space, venue layouts, event configurations, guest maximums per configuration, venue hours, venue licensing and planning details such doorways, hallways, location of walls, location of entries and exits, and the location of the kitchen, access and delivery details.

The environmental data 412 may be received or collected from a variety of sources. In one embodiment, the venue inputs the environment data through user interface 430. For example, the environment data may be retrieved from photographs, CAD drawings, Word documents, PowerPoint, Photoshop configurations or the like, supplied by the venue. In another embodiment, the venue may input various parameters of the venue space, logistics, product offerings, contents and the like through user interface 430, including measurements of the length and depth of the room, wall dimensions, floor space, and the like. The environmental data may also include virtual object data specific to the venue. In one embodiment, the user selects a virtual object from a library of virtual objects stored in the environment database 412. The user then may arrange the virtual objects within the virtual venue to determine the feasibility of their desired layout.

Database system 410 also includes product database 414. The product data defines attributes of actual products available through the venue or third party vendors. The system 400 is used to allow the user to create an event that includes various products and enables the user to arrange the products within the selected configuration. Similarly, database system 410 includes a services database 416 that defines attributes of virtual representations of actual services available through the venue or third party vendors. The system 400 is used to allow the user to select, deselect, rearrange, configure and reconfigure the various products within the venue as part of the users' event creation process.

Similarly, database system 410 includes a services database 416 that defines details, information, descriptions and attributes of the services available through the venue or third party vendors. The system 400 is used to allow the user to select, deselect, rearrange, configure and reconfigure the various services within the venue as part of the users' event creation process.

In some embodiments, the system can include a rendering engine 413 that functions to generate the data embedded photographic representations of venues and associated event parameters that are added to the venue representation.

In various embodiments, the product and service data may be collected from various sources. The product and service data may be input through user interface 430. For example, the products and services data may be scrapped from the venue website or website input data files. Environment data may be retrieved from photographs, CAD drawings, or the like, or supplied by the venue and/or the third party vendors. In another embodiment, the venue may input various parameters of the venue space and data containing products and services descriptions and details, as well pricing, payment terms, policies and procedures, logistics and coordination parameters through user interface 430. In still other embodiments, the product and service data as well as the related descriptions details, pricing, payment terms, policies and procedure, logistics and coordination parameters are received from a retail database of participating vendors.

User interface 430 allows the user to select the venue, the desired products and/or services and create their virtual event according to their preferred special configuration. The event creation generator 446 is configured to generate a virtual simulation of the created event for that user for the selected venue can be viewed by the user on the visual display 420. The simulation of the event allows the user to control the event creation process by deselecting and reselecting the products and/or services throughout the virtual space.

User interface 430 allows the user, the venue, the third party vendor, and any other relevant participants in the event booking system user interface, to input feedback regarding the experience. In various embodiments, system 400 can be configured to execute various processes for receiving or collecting input from the users that can be utilized to provide feedback to the relevant participants. System 400 may provide an analysis of the feedback and deduce possible improvements or changes the various participants might make to create a more efficient and enjoyable user experience.

According to some embodiments, the systems of the present disclosure can be configured to execute various processes for receiving or collecting input from the users that can be utilized to create a notification scheme comprising a collection of data that causes the system to send various notifications regarding the event planning process and event execution. The user may receive an audio notification or a visual notification regarding scheduled tasks associated with the event. The notifications may be in text form, via electronic mail, or the like. The type of notification will depend on the type of computing device utilized by the user and may include, but are not limited to: phones, tablets, watches, glasses, or other forms of wearable computing.

In some embodiments, the systems of the present disclosure then collect and analyze the data that has been entered at various points by each user to establish the appropriate type of notification, as well as, the date and time the notification should be sent to the user. These notifications may be received in a days out format, which will notify the user of how many days the specific task needs to be completed prior to the event itself. The systems of the present disclosure will then provide a visual display of the actual date and time that each task is to be completed so that the user is presented with a visual reminder of the pending deadline.

In some embodiments, once the event creator has input their event requirements, including but not limited by the venue selection, products and/or services requested, date and time of the event, and any other personal preferences, the systems of the present disclosure store the data in the notification scheme, which is compared to the data input from the venue and the selected third party vendors. The notification scheme then tags the pieces of data relevant to the venue, the third party vendor or both and generates notifications necessary to streamline the event planning process. These notifications may be transmitted directly from the system to the venue, the third party vendor, or both, eliminating unnecessary involvement by the event creator and placing the burden of schedule coordination and event execution on the venue and third party vendors. In various embodiments, the event creator may opt in or out of receiving the event notifications depending on their preferred level of involvement.

For example, once the system has collected all the information required to create the venue event calendar, the event creator will be presented with a visual display of all the associated data points necessary to begin scheduling their event. The visual display may be in a 12 month calendar format, weekly format, list format, or the like, depending on the user's preference. The user can then make the necessary selections from the user interface that meet their specific event requirements. Once the user has made all of their preferred selections, the system will generate notifications in the form of a text message, email message, or the like, to be sent to all the involved parties. These notifications will advise each user of when specific aspects of the event need to be executed. For example, if an event creator has a specific food requirement, such as gluten free preferences, the notification scheme will send a notification to the venue and/or third party vendor as to how many days prior to the event the food needs to be prepared in order to meet the event creator's specifications.

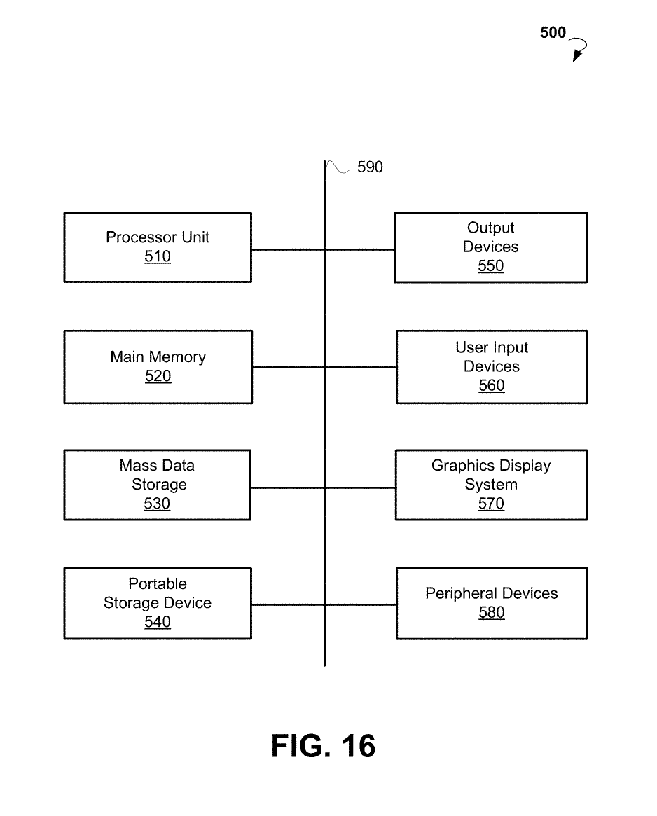

FIG. 16 illustrates an exemplary computer system 500 that may be used to implement some embodiments of the present invention. The computer system 500 of FIG. 16 may be implemented in the contexts of the likes of computing systems, networks, servers, or combinations thereof. The computer system 500 of FIG. 16 includes one or more processor units 510 and main memory 520. Main memory 520 stores, in part, instructions and data for execution by processor units 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580.

The components shown in FIG. 16 are depicted as being connected via a single bus 590. The components may be connected through one or more data transport means. Processor unit 510 and main memory 520 is connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 include a liquid crystal display (LCD) or other suitable display device. Graphics display system 570 is configurable to receive textual and graphical information and processes the information for output to the display device.

Peripheral devices 580 may include any type of computer support device to add additional functionality to the computer system.

The components provided in the computer system 500 of FIG. 8 are those typically found in computer systems that may be suitable for use with embodiments of the present disclosure and are intended to represent a broad category of such computer components that are well known in the art. Thus, the computer system 500 of FIG. 8 can be a PC, hand held computer system, telephone, mobile computer system, workstation, tablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN and other suitable operating systems.

The processing for various embodiments may be implemented in software that is cloud-based. In some embodiments, the computer system 500 is implemented as a cloud-based computing environment, such as a virtual machine operating within a computing cloud. In other embodiments, the computer system 500 may itself include a cloud-based computing environment, where the functionalities of the computer system 500 are executed in a distributed fashion. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer device 300, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments

1. A method, comprising:
providing a plurality of data embedded visual cues, wherein the plurality of data embedded visual cues comprise images of physical venues, each of the plurality of data embedded visual cues embedding venue offers, venue capabilities, and venue market position;
receiving selections of the plurality of data embedded visual cues;
analyzing the selections to determine one or more venue suggestions that are indicative of venues that correspond to the selections;
generating one or more venue suggestions based on the selections;
receiving selections of event parameters for an event relative to the venues corresponding to the one or more venue suggestions; and
generating an event recommendation based on the selections of event parameters and the selected one or more venue suggestions.

2. The method according to claim 1, wherein the event parameters are curated from supplier goods and services such that they correspond to the embedded venue offers, venue capabilities, and venue market position of the selected venues.

3. The method according to claim 1, wherein providing a plurality of data embedded visual cues comprises generating data embedded images of the physical venues that are staged in accordance with the embedded venue offers, venue capabilities, and venue market position.

4. The method according to claim 1, wherein the venue offers, venue capabilities, and venue market position comprise an event calendar, room hire, room or venue specifications and staffing, food menus, drinks menus and so forth.

5. The method according to claim 1, further comprising generating pre-populated agreements for the selections of event parameters and the selected venues.

6. The method according to claim 1, wherein supplier goods and services are curated into product and service subcategories.

7. The method according to claim 1, wherein selection of one of the subcategories results in displaying of subcategory options for the selected subcategory, wherein the subcategory options are tailored based on the venue selections.

8. The method according to claim 1, wherein the event parameters are populated as objects within the event recommendation that comprises the selected data embedded visual cue of the venue selections.

9. The method according to claim 8, wherein a user can selectively rearrange the objects within the selected data embedded visual cue of the venue selections.

10. The method according to claim 9, wherein a user can selectively change a view point for viewing the selected data embedded visual cue using gesture-based inputs on a touchscreen device.

11. The method according to claim 1, further comprising providing selectable event types, each of the selectable event types being associated with at least one of the physical venues.

12. The method according to claim 11, further comprising displaying one or more interactive plan views of the physical venues of the one or more venue suggestions selected, the interactive plan views comprising venue objects that are movable within the interactive plan views.

13. The method according to claim 12, further comprising re-generating the selected data embedded visual cue of the physical venues after receiving manipulations of venue objects within the interactive plan views.

14. The method according to claim 1, wherein the images of physical venues comprise staged images.

15. A method, comprising:
generating an image-based event recommendation based on selections of event parameters and venue suggestions that occur through only provision and selection of images by:
displaying a plurality of data embedded visual cues, the plurality of data embedded visual cues comprise images of physical venues, the plurality of data embedded visual cues embedding venue attributes;
receiving a selection of the plurality of data embedded visual cues;
displaying images related to event parameters for an event relative to the physical venue corresponding to the venue suggestion;
receiving selections of the event parameters; and
generating a proposal that comprises the selected data embedded visual cue of the physical venue in combination with the event parameters.

16. The method according to claim 15, further comprising displaying a staged image of the selected venue suggestion based on the selection of the plurality of data embedded visual cues.

17. The method according to claim 15, wherein the event parameters comprise services and products of vendors that are matched to data embedded into the plurality of data embedded visual cues.

18. The method according to claim 17, further comprising:
generating contracts that are automatically populated within a user interface for any of:
the products and services of the vendors; and
the selected venue; and
providing the contracts to a purchaser.
